(19) United States
(12) Patent Application Publication
(10) Pub. No.: US 2008/0137057 A1
(43) Pub. Date: Jun. 12, 2008

(54) FILM HOLDER FOR SUPPORTING POSITIVE FILM OR NEGATIVE FILM

(75) Inventor: Hsi-Tien Tang, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 11/673,393

(22) Filed: Feb. 9, 2007

(30) Foreign Application Priority Data
Dec. 8, 2006 (TW) 095145920

(51) Int. Cl. G03B 27/62

(52) U.S. Cl. 355/75

(57) ABSTRACT

The present invention relates to a film holder for supporting at least one positive film or negative film. The film holder includes a rectangular base member and a rectangular cover member. The rectangular base member includes two long edges and two short edges. The rectangular base member further includes a rectangular concave portion for receiving the positive film or the negative film therein. The rectangular cover member includes two long rims and two short rims for fixing the positive film or the negative film on the rectangular base member. One of the two short rims of the rectangular cover member is pivotal about one of the two short edges of the rectangular base member and received within the rectangular concave portion.

### FIELD OF THE INVENTION

The present invention relates to a film holder, and more particularly to a film holder for supporting at least one positive film or negative film.

### BACKGROUND OF THE INVENTION

With digitalized trend, scanners or multifunction peripherals are widely used to scan images of objects. The scanned images can be converted into digital electronic files. The digital electronic files may be stored in a computer. Moreover, some digitalized processing operations such as digital display, editing, saving and outputting operations may be performed on the digital electronic files by the computer. Generally, the objects to be scanned include opaque objects and transparent objects. Examples of the opaque objects include paper sheets, photographs, etc., and the common transparent objects are for example transparencies, slides and films. Depending on the property of the scanned object, different types of scanners are used. For example, a transmissive scanner is used for scanning transparent objects and the thus scanned images are converted into digital electronic files.

Conventionally, a film holder is used for supporting a plurality of positive films or negative films in position at the same time. Please refer to FIG. 1, which is a schematic top view of a film holder disclosed in Taiwanese Patent Gazette No. TWI241124. As shown in FIG. 1, the film holder 100 includes a rectangular base member 110 and a rectangular cover member 120. The rectangular base member 110 includes a negative film receiving recess 112, several positive film receiving recesses 114, several fit holes 116, several ribs 118, a locking element 130, two engaging elements 132 and two confining elements 134. The negative film receiving recess 112 is rectangular and shallow to receive a plastic film (i.e. a negative film). Positive films such as slides may be held in the positive film receiving recesses 114. In a case that a negative film is received in the negative film receiving recess 112, a short edge of the negative film is confined and fixed by the confining elements 134 in position. Via the locking element 130 and the engaging elements 132, the film holder 100 will be attached onto the backlight plate (not shown) of the image processing apparatus. On the inner surface 122 of the rectangular cover member 120, several protrusion elements 124, elastic elements 126 and latch elements 128 are provided. The latch elements 128 are engaged with corresponding fit holes 116, so that the rectangular cover member 120 is fixed to the rectangular base member 110 when the rectangular cover member 120 is closed. In a case that positive films are received in the positive film receiving recesses 114, the inner surface 122 and the elastic elements 126 will come into contact with upper surfaces of the positive films in the positive film receiving recesses 114 once the rectangular cover member 120 is closed. The ribs 118 are discretely arranged at regular intervals in the longitudinal direction of the rectangular base member 110, so that the upper and lower edges of the positive film receiving recesses 114 are defined by the intervals between adjacent ribs 118. In another case that negative films are intended to be held, the protrusion elements 124 and the ribs 118 come into contact with upper surfaces of the negative films held in the negative film receiving recess 112 once the rectangular cover member 120 is closed.

FIG. 2 is a schematic front view illustrating that the positive films 192 are supported on the conventional film holder 100. FIG. 3 is a schematic front view illustrating that a negative film 194 is supported on the conventional film holder 100. As shown in FIGS. 2 and 3, the width of the positive film 192 is larger than that of the negative film 194. The upper and lower edges of two positive film receiving recesses 114 are extended from the negative film receiving recess 112 and defined by the intervals between adjacent ribs 118. For scanning the positive films 192, the positive films 192 should be received in the positive film receiving recesses 114 as shown in FIG. 2. For scanning the negative film 194, the strip of negative film 194 should be received in the negative film receiving recess 112 as shown in FIG. 3. In addition, a short edge of the negative film 194 is confined by the confining elements 134 in position, and two long edges of the negative film 194 is confined by the ribs 118.

Since the protrusion elements 124 is protruded from the inner surface 122 of the rectangular cover member 120, the negative film 194 held in the negative film receiving recess 112 may be fixed by the protrusion elements 124 when the rectangular cover member 120 is closed. Typically, the negative film 194 is thinner than the positive film 192. In a case that positive films 192 are received in the positive film receiving recesses 114, the edges of positive films 192 are fixed by the inner surface 122 when the rectangular cover member 120 is closed. If the edges of the positive film 192 are usually uneven, the positive film 192 is likely loosened when the inner surface 122 of the rectangular cover member 120 comes into contact with the positive film 192. Under this circumstance, the elastic elements 126 are necessary to facilitate close contact with the edges of the positive film 192 so as to securely fix the positive film 192.

Please refer to FIG. 1 again. The rectangular cover member 120 is pivotal about the rectangular base member 110 with respect to a hinge 150. The hinge 150 is provided on the long edge A of the rectangular cover member 120 to enable the rectangular cover member 120 to open and close. The latch elements 128 are arranged on another long edge B of the rectangular cover member 120. When the rectangular cover member 120 is rotated toward the rectangular base member 110 until the latch elements 128 are engaged with corresponding fit holes 116, the long edge B of the rectangular cover member 120 is fixed on the rectangular base member 110. Since the hinge 150 is provided on the long edge A of the rectangular cover member 120, the latch elements 128 needs to be arranged on only a single long edge B of the rectangular cover member 120. The engagement between the latch elements 128 and the fit holes 116 is insufficient to render secure attachment of the rectangular cover member 120 onto the rectangular base member 110. In addition, since rectangular cover member 120 is pivotal about the rectangular base member 110 with respect to the hinge 150, the rectangular cover member 120 may be opened by uplifting the single long edge B of the rectangular cover member 120. As a consequence, the procedure of opening the rectangular cover member 120 is neither convenient nor user-friendly. Moreover, in a case that positive films 192 are received in the positive film receiving recesses 114 and then the rectangular cover member 120 is closed, a first gap is formed between the long edge A of the rectangular cover member 120 and the rectangular base member 110 and a second gap is formed between the long edge B of the rectangular cover member 120 and the rectangular base member. Since the hinge 150 arranged on the long edge A of the rectangular cover member 120 has a height, the first gap is larger than the second gap. As a consequence, the pressing forces exerted by the inner surface 122 and the elastic elements 126 on the long edges A and B are not uniformly distributed. During a scanning operation is performed by the scanning module of the scanning apparatus, the depth-of-fields in the vicinity of the long edge A and B are distinguished such that the scanned image has impaired quality or image distortion is caused.

Therefore, there is a need to provide a film holder for supporting at least one positive film or negative film so as to reduce image distortion and improve the quality of the scanned image.

### SUMMARY OF THE INVENTION

It is an object of the present invention to provide a film holder for supporting at least one positive film or negative film without impairing the quality of the scanned image.

In accordance with an aspect of the present invention, there is provided a film holder for supporting at least one positive film or negative film. The film holder includes a rectangular base member and a rectangular cover member. The rectangular base member includes two long edges and two short edges. The rectangular base member further includes a rectangular concave portion for receiving the positive film or the negative film therein. The rectangular cover member includes two long rims and two short rims for fixing the positive film or the negative film on the rectangular base member. One of the two short rims of the rectangular cover member is pivotal about one of the two short edges of the rectangular base member and received within the rectangular concave portion.

In an embodiment, the film holder further includes multiple fit holes and multiple latch elements. The fit holes are arranged in the two long edges of the rectangular base member in the vicinity of the rectangular concave portion. The latch elements are arranged on the two long rims of the rectangular cover member and corresponding to the fit holes so to be engageable with the fit holes.

In an embodiment, each of the latch elements arranged on the two long rims and adjacent to the two short rims of the rectangular cover member includes a slant.

In an embodiment, the rectangular base member further includes multiple ribs in the vicinity of the rectangular concave portion to define positive film receiving portions.

In an embodiment, the rectangular cover member further includes multiple post elements on the two long rims for pressing the negative film.

In an embodiment, the rectangular cover member further includes multiple elastic elements on the two long rims thereof for pressing the positive film.

Preferably, the rectangular cover member is made of flexible plastic material.

In an embodiment, the rectangular cover member further includes multiple elastic buttons on the two long rims thereof.

In an embodiment, the rectangular base member further includes a locking element and two engaging elements for facilitate the film holder to be attached onto a backlight plate of an image processing apparatus therevia.

In accordance with another aspect of the present invention, there is provided an image processing apparatus for scanning at least one positive film or negative film. The image processing apparatus includes a backlight plate, a transparent platform, a scanning module and a film holder. The transparent platform is used for placing the positive film or the negative film thereon. The scanning module is used for scanning the positive film or the negative film. The film holder is detachably mounted on the backlight plate and includes a rectangular base member and a rectangular cover member. The rectangular base member includes two long edges and two short edges and has a rectangular concave portion for receiving the positive film or the negative film therein. The rectangular cover member includes two long rims and two short rims for fixing the positive film or the negative film on the rectangular base member. One of the two short rims of the rectangular cover member is pivotal about one of the two short edges of the rectangular base member and received within the rectangular concave portion.

Preferably, the image processing apparatus is a scanner or a multifunction peripheral.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a conventional film holder;

FIG. 2 schematically illustrates that the positive films are supported on the conventional film holder;

FIG. 3 schematically illustrates that a negative film is supported on the conventional film holder;

FIGS. 4(a), 4(b) and 4(c) are schematic views of a film holder according to a preferred embodiment of the present invention;

FIG. 5 schematically illustrates that positive films are positioned in the film holder of the present invention;

FIG. 6 schematically illustrates that a negative film are positioned in the film holder of the present invention; and

FIG. 7 is a schematic perspective view illustrating that a film holder of the present invention is attached onto an image processing apparatus.

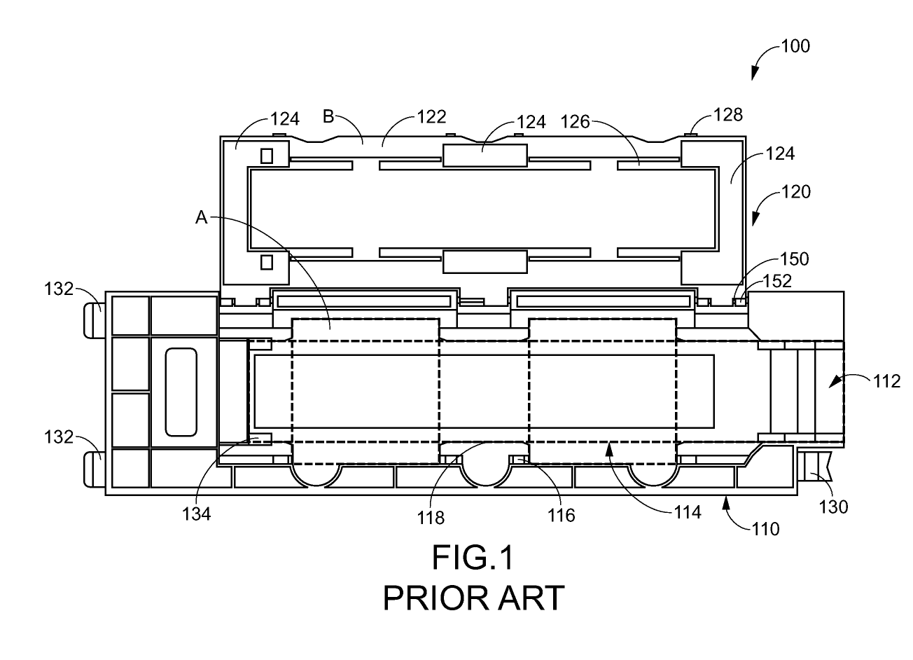

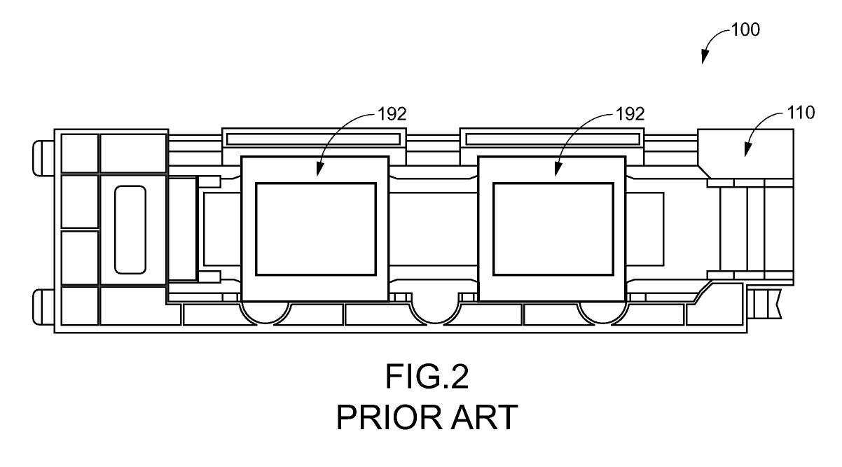

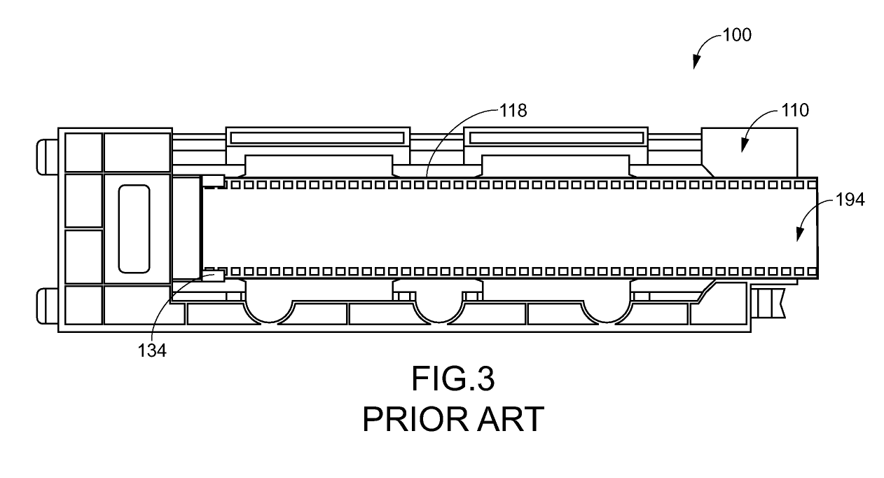

### DETAILED DESCRIPTION OF THE PREFERRED EMBODIMENT

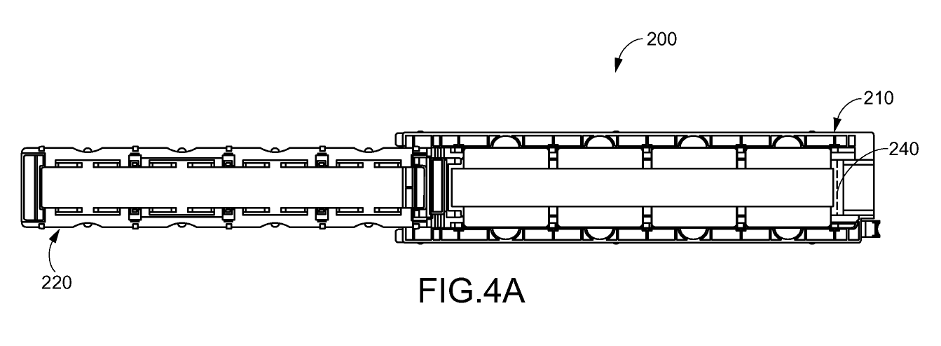

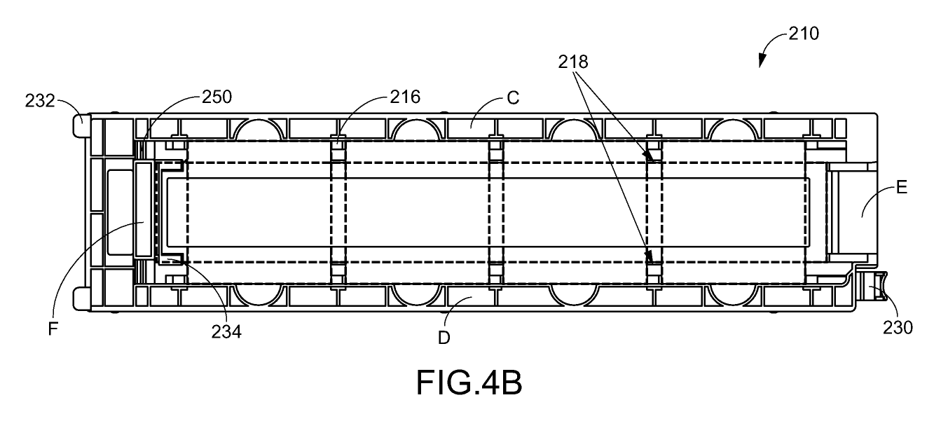

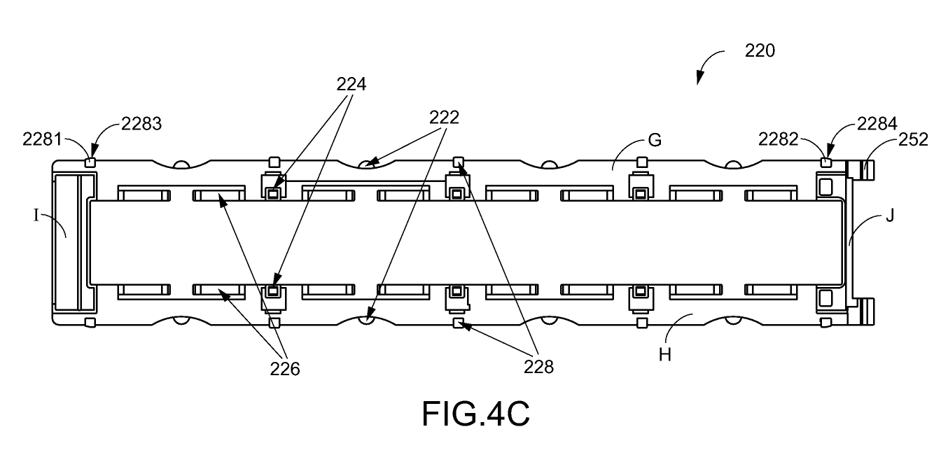

For reducing image distortion and improving the quality of the scanned image, the present invention provides a film holder capable of supporting positive films or negative films. Referring to FIGS. 4(a), 4(b) and 4(c), schematic views of a film holder according to a preferred embodiment of the present invention are illustrated. As shown in FIGS. 4(a), 4(b) and 4(c), the film holder 200 includes a rectangular base member 210 and a rectangular cover member 220. The rectangular base member 210 includes a first long edge C, a second long edge D, a first short edge E and a second short edge F. The rectangular base member 210 further includes a rectangular concave portion 240, a locking element 230 and two engaging elements 232. The rectangular cover member 220 also includes a first long rim G, a second long rim H, a first short rim I and a second short rim J. A rotating shaft 250 and a hooking element 252 are arranged on the second short edge F of the rectangular base member 210 and the second short rim J of the rectangular cover member 220, respectively. The rotating shaft 250 and the hooking element 252 are cooperatively formed as a hinge. The rectangular cover member 220 is pivotal about the rectangular base member 210 with respect to the hinge to enable the rectangular cover member 220 to open and close.

In the vicinity of the rectangular concave portion 240, the first long edge C and the second long edge D of the rectangular base member 210 include multiple fit holes 216. Several ribs 218 are provided on the rectangular base member 210 and extended from corresponding fit holes 216 to the rectangular concave portion 240. Since the ribs 218 are discretely arranged at regular intervals in the longitudinal direction of the rectangular base member 210, several positive film receiving recesses are defined by the intervals between adjacent ribs 218. The first long rim G and the second long rim H of the rectangular cover member 220 include multiple latch elements 228 corresponding to the locations of the fit holes 216 in the rectangular base member 210. Each of the latch elements 228 located on the long rims G and H includes a slant. The latch elements 228 adjacent to the first short rim I are first slant latch elements 2281 with first slants 2283. The latch elements 228 adjacent to the second short rim J are second slant latch elements 2282 with second slants 2284. The rectangular cover member 220 further includes multiple elastic buttons 222 between every two adjacent latch elements 228. In the vicinity of the hollow portion in the center of the rectangular cover member 220, the first long rim G and the second long rim H of the rectangular cover member 220 further include multiple elastic elements 226 and multiple post elements 224 corresponding to the elastic buttons 222 and the latch elements 228 (excluding the slant latch elements 2281 and 2282), respectively. In order to support positive film or negative films on the film holder 200, the rectangular cover member 220 needs to be opened in advance.

Hereinafter, the process of opening the rectangular cover member 220 will be illustrated as follows. First of all, in response to the clamping and pressing forces exerted by the user's fingers, the elastic buttons 222 on the long rims G and H of the rectangular cover member 220 are clamped and pressed down. Once the clamping and pressing forces are continuously applied, the rectangular cover member 220 is subject to deformation and then the latch elements 228 are disengaged from the fit holes 216. Afterwards, the rectangular cover member 220 is rotated upwardly such that the rectangular cover member 220 is opened.

In an embodiment, since the slant latch elements 2281, 2282 have the slants 2283, 2284, the slant latch elements 2281, 2282 are easily disengaged from corresponding fit holes 216 when compared with the disengagement between the ordinary latch elements 228 (excluding the slant latch elements 2281 and 2282) and corresponding fit holes 216. After the clamping and pressing forces applied on the rectangular cover member 220 are eliminated, the rectangular cover member 220 will return to its original shape because the rectangular cover member 220 is made of flexible plastic material.

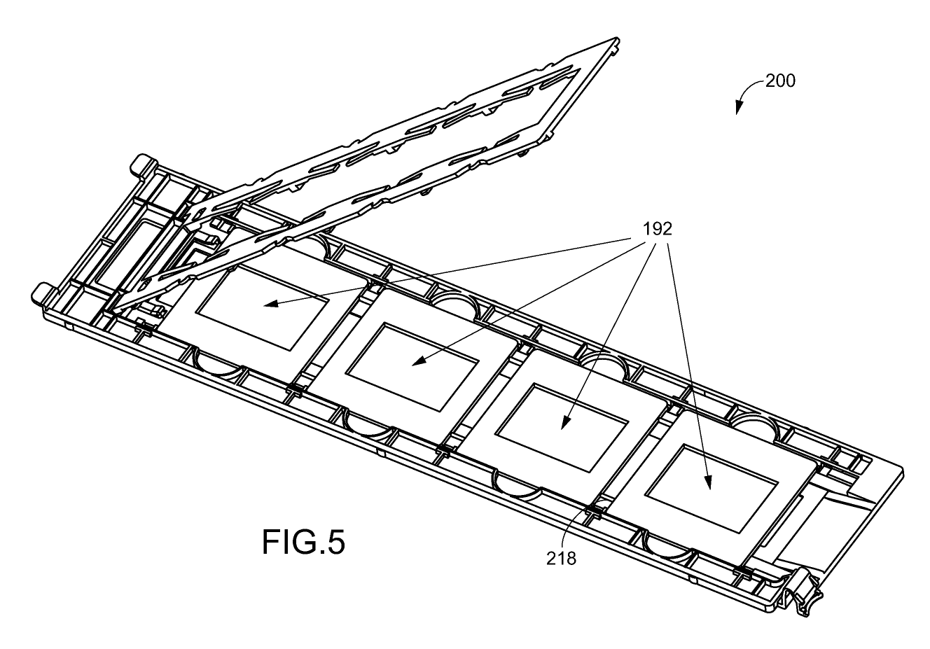

After the rectangular cover member 220 is opened, the positive film or negative films may be placed into the rectangular concave portion 240. For a purpose of scanning positive films, the positive films need to be placed into the rectangular concave portion 240 and positioned in the positive film receiving recesses, which are defined by the ribs 218. As shown in FIG. 5, after the positive films 192 are positioned in the positive film receiving recesses, the rotating shaft 250 is pivotal about the rectangular base member 210 to enable the rectangular cover member 220 to close, so that the positive films 192 are supported and fixed on the film holder 200. During the rectangular cover member 220 is closed, the second slants 2284 of the second slant latch elements 2282 may facilitate the latch elements 228 to enter the rectangular concave portion 240 and engage with corresponding fit holes 216. Once the rectangular cover member 220 is closed, the elastic elements 226 of the long rims G and H come into contact with upper surfaces of the positive films 192 held in the positive film receiving recesses. Even though the edges of the positive films 192 are uneven, the elastic elements 226 may facilitate close contact with the edges of the positive film 192 so as to securely fix the positive film 192.

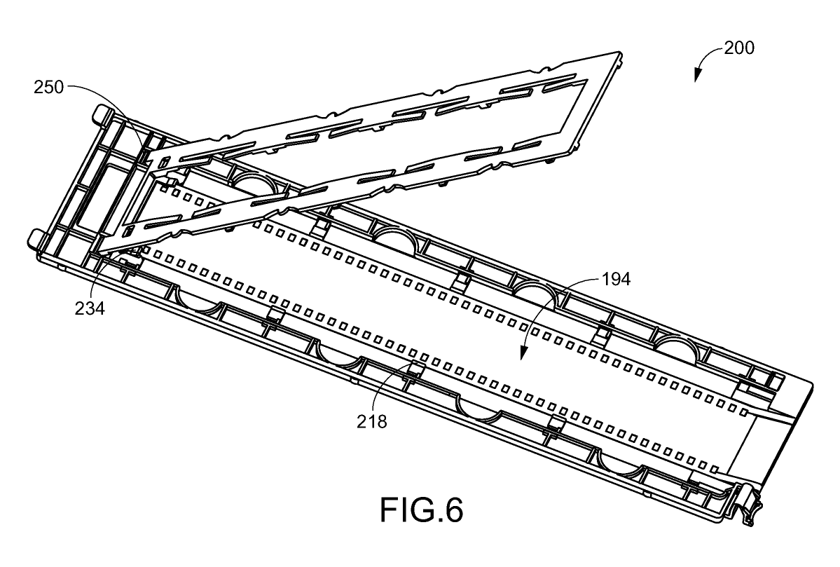

For a purpose of scanning negative films, the rectangular cover member 220 needs to be opened as described above. Then, the negative films are placed into the rectangular concave portion 240. Meanwhile, a short edge of the negative film is confined and fixed by the confining elements 234 and the two long edges of the negative film are confined by the ribs 218. As shown in FIG. 6, after the negative film 192 is positioned in the rectangular concave portion 240, the rotating shaft 250 is pivotal about the rectangular base member 210 to enable the rectangular cover member 220 to close, so that the negative film 192 is supported and fixed on the film holder 200. During the rectangular cover member 220 is closed, the post elements 224 on the long rims G and H of the rectangular cover member 220 may press the negative film 192 to facilitate fixing the negative film 192.

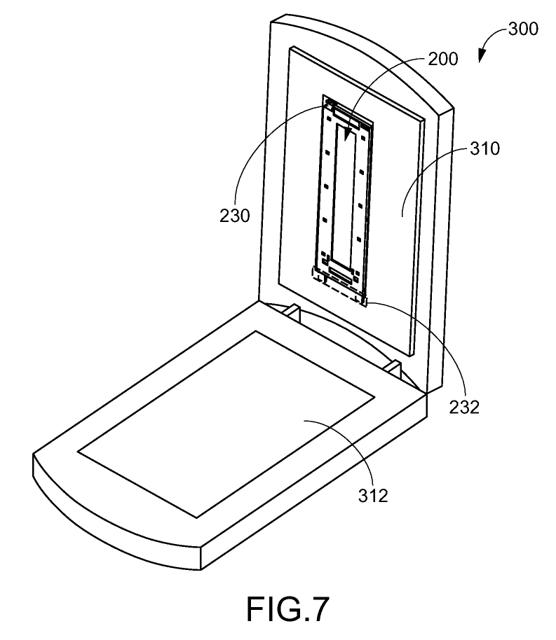

Please refer to FIG. 7, which is a schematic perspective view illustrating a film holder of the present invention attached onto an image processing apparatus. The image processing apparatus 300 includes a backlight plate 310, a transparent platform 310, a scanning module (not shown) and the film holder 200. The film holder 200 is attached onto the backlight plate 310 of the image processing apparatus 300 via the locking element 230 and the engaging elements 232.

After the positive film or negative films are supported on the film holder 200, the film holder 200 may be attached onto the image processing apparatus 300 via the locking element 230 and the engaging elements 232. An example of the image processing apparatus 300 includes a scanner or a multifunction peripheral. Meanwhile, the scanning module (not shown) may perform scanning operations on the positive film or negative films, which are supported on the film holder 200.

As previously described, since the latch elements 128 are arranged on only a single long edge of the rectangular cover member 120 according to the prior art, the engagement between the latch elements 128 and the fit holes 116 is insufficient to render secure attachment of the rectangular cover member 120 onto the rectangular base member 110. According to the present invention, by exerting external forces on elastic buttons 222 at both long rims of the rectangular cover member 220, the rectangular cover member 220 is uplifted without difficulty. Moreover, since the rotating shaft 250 is arranged on the second short edge F of the rectangular base member 210, the external forces applied on the two long edges of film holder 200 are even, so that the problem of causing image distortion is minimized. Since the latch elements 228 on two long edges of the rectangular cover member 220 are two times of the latch elements 128 of the rectangular cover member 120, the engagements between the latch elements 228 and the fit holes 216 are sufficient to render secure attachment of the rectangular cover member 220 onto the rectangular base member 210. From the above description, the film holder of the present invention is more user-friendly and effective to enhance the quality of the scanned image.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A film holder for supporting at least one positive film or negative film, said film holder comprising:
a rectangular base member including two long edges and two short edges, wherein said rectangular base member further includes a rectangular concave portion for receiving said positive film or said negative film therein; and
a rectangular cover member including two long rims and two short rims for fixing said positive film or said negative film on said rectangular base member, wherein one of said two short rims of said rectangular cover member is pivotal about one of said two short edges of said rectangular base member and received within said rectangular concave portion.

2. The film holder according to claim 1 further including:
multiple fit holes arranged in said two long edges of said rectangular base member in the vicinity of said rectangular concave portion; and
multiple latch elements arranged on said two long rims of said rectangular cover member and corresponding to said fit holes so to be engageable with said fit holes.

3. The film holder according to claim 2 wherein each of said latch elements arranged on said two long rims and adjacent to said two short rims of said rectangular cover member includes a slant.

4. The film holder according to claim 1 wherein said rectangular base member further includes multiple ribs in the vicinity of said rectangular concave portion to define positive film receiving portions.

5. The film holder according to claim 1 wherein said rectangular cover member further includes multiple post elements on said two long rims for pressing said negative film.

6. The film holder according to claim 1 wherein said rectangular cover member further includes multiple elastic elements on said two long rims thereof for pressing said positive film.

7. The film holder according to claim 1 wherein said rectangular cover member is made of flexible plastic material.

8. The film holder according to claim 7 wherein said rectangular cover member further includes multiple elastic buttons on said two long rims thereof.

9. The film holder according to claim 1 wherein said rectangular base member further includes a locking element and two engaging elements for facilitate said film holder to be attached onto a backlight plate of an image processing apparatus therevia.

10. An image processing apparatus for scanning at least one positive film or negative film, said image processing apparatus comprising:
a backlight plate;
a transparent platform for placing said positive film or said negative film thereon;
a scanning module for scanning said positive film or said negative film; and
a film holder detachably mounted on said backlight plate and including a rectangular base member and a rectangular cover member, wherein said rectangular base member includes two long edges and two short edges and has a rectangular concave portion for receiving said positive film or said negative film therein, said rectangular cover member includes two long rims and two short rims for fixing said positive film or said negative film on said rectangular base member, and one of said two short rims of said rectangular cover member is pivotal about one of said two short edges of said rectangular base member and received within said rectangular concave portion.

11. The image processing apparatus according to claim 10 wherein said image processing apparatus is a scanner or a multifunction peripheral.
